(19) United States
(12) Patent Application Publication
(10) Pub. No.: US 2025/0340220 A1
(43) Pub. Date: Nov. 6, 2025

(54) LOCAL PATH PLANNING

(71) Applicant: Honda Motor Co., Ltd., Tokyo (JP)

(72) Inventors: Faizan M. TARIQ, San Jose, CA (US); Zheng-Hang YEH, San Jose, CA (US); Avinash SINGH, Santa Clara, CA (US); David F. ISELE, Sunnyvale, CA (US); Sangjae BAE, San Jose, CA (US)

(21) Appl. No.: 19/040,097

(22) Filed: Jan. 29, 2025

Related U.S. Application Data
(60) Provisional application No. 63/641,273, filed on May 1, 2024.

(51) Int. Cl. B60W 60/00

(52) U.S. Cl. CPC B60W 60/00276; B60W 2554/4029

(57) ABSTRACT

According to one aspect, local path planning may be achieved using a sensor, a memory, a processor, a controller, and an actuator. The sensor may detect two or more objects within an operating environment. The memory may store one or more instructions. The processor may execute one or more of the instructions stored on the memory to perform one or more acts, actions, and/or steps. The processor may generate bounding box information for bounding boxes of the two or more objects. The processor may generate an envelop graph structure based on the bounding box information. The processor may generate a local path planning trajectory from a start region to a goal region within the envelop graph structure based on a cost function and the envelop graph structure. The controller may control the actuator to execute the local path planning trajectory for the autonomous vehicle.

### CROSS-REFERENCE TO RELATED APPLICATIONS

This application claims the benefit of U.S. Provisional Patent Application, Ser. No. 63/641,273 entitled “EFFICIENT RISK-AWARE LOCAL PATH PLANNING FRAMEWORK FOR AUTONOMOUS DRIVING”, filed on May 1, 2024; the entirety of the above-noted application(s) is incorporated by reference herein.

### BACKGROUND

In the presence of oncoming traffic, an autonomous vehicle may deviate from a lane center to avoid a collision with vehicles parked on a side of the roadway. In the absence of a local path planning modification scheme, the autonomous vehicle may end up waiting an extended period of time for the parked vehicles to move before continuing on a pre-determined path.

### BRIEF DESCRIPTION

According to one aspect, a system for local path planning may include a memory and a processor. The memory may store one or more instructions. The processor may execute one or more of the instructions stored on the memory to perform one or more acts, actions, and/or steps. The processor may generate an envelop graph structure based on bounding box information for bounding boxes of two or more objects within an operating environment. The processor may generate a local path planning trajectory from a start region to a goal region within the envelop graph structure based on a cost function and the envelop graph structure.

According to one aspect, a computer-implemented method for local path planning may include generating an envelop graph structure based on bounding box information for bounding boxes of two or more objects within an operating environment and generating a local path planning trajectory from a start region to a goal region within the envelop graph structure based on a cost function and the envelop graph structure.

According to one aspect, an autonomous vehicle with local path planning may include a sensor, a memory, a processor, a controller, and an actuator. The sensor may detect two or more objects within an operating environment. The memory may store one or more instructions. The processor may execute one or more of the instructions stored on the memory to perform one or more acts, actions, and/or steps. The processor may generate bounding box information for bounding boxes of the two or more objects. The processor may generate an envelop graph structure based on the bounding box information. The processor may generate a local path planning trajectory from a start region to a goal region within the envelop graph structure based on a cost function and the envelop graph structure. The controller may control the actuator to execute the local path planning trajectory for the autonomous vehicle.

### BRIEF DESCRIPTION OF THE DRAWINGS

FIG. 1 is an exemplary flow diagram of a computer-implemented method for local path planning, according to one aspect.

FIG. 2 is an exemplary component diagram of a system for local path planning, according to one aspect.

FIG. 3 is an exemplary algorithm in association with the computer-implemented method for local path planning of FIG. 1 and the system for local path planning of FIG. 2, according to one aspect.

FIGS. 4A-4C are exemplary graphs in association with local path planning, according to one aspect.

FIG. 5 is an illustration of an example computing environment where one or more of the provisions set forth herein are implemented, according to one aspect.

FIG. 6 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

An “ego-vehicle”, as used herein, may describe an autonomous vehicle equipped with a system for local path planning, including sensors that perceive the operating environment around the ego-vehicle, described in greater detail herein. In other words, the “ego vehicle” is the autonomous vehicle that is being controlled by an autonomous driving system. It is noted, however, that the operating environment may include one or more other autonomous vehicles, not to be confused with the ego-vehicle.

A “vehicle system”, as used herein, may be any automatic or manual system that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

Path-speed decomposition-based trajectory planning schemes have garnered widespread usage in real-world robotics applications due to their efficacy and computational efficiency. While a global route or global path may be planned offline, generating a local path adaptive to real-time situations online remains desirable. A local path planning algorithm, which may be executed via a processor, a memory, a storage drive, a controller, and an actuator via a system for local path planning, is provided herein that prioritizes smoothness and low computational complexity, thereby facilitating scalability to dense environments with various on-road entities. The local path planning algorithm leverages a sparse graph structure (e.g., envelop graph structure) to generate object-specific nodes and connect the object-specific nodes via spline edges. Further, modifications or variations may be introduced to provide the advantage of graph sparsity, thereby boosting computational efficiency without compromising performance. According to one aspect, path evaluation may include consideration of path smoothness as well as risk pertaining to other road users.

Motivated by the practical requirements of reliability and computational efficiency, the path-speed decomposition approach may be considered effective for various trajectory planning tasks (e.g., including local path planning). By separating the path generation and speed planning processes, the complexities of trajectory optimization may be broken down into manageable sub-problems to be tackled independently. The formulation of a path planning problem by the algorithm enables the problem to be solvable in real-time or within a short planning horizon (e.g., a couple of seconds). While this decomposition comes at a cost of discarding some trajectories where the path and speed are tightly coupled, the improved runtime provides the benefit of enabling vehicles to adapt to various driving scenarios, such as urban environments, highway cruising, or even off-road terrain, with greater precision and efficiency.

The system for local path planning may leverage the decomposition scheme to develop an efficient risk-aware local path planning strategy. For example, the processor may generate a global path at the outset of operation using map data. However, this global path may be created in the absence of local information, thereby creating a need for an updated route in real-time or at runtime. For example, parked vehicles on the roadside may cause deviation from the lane center specified by the global path. Concurrently, this deviated path should also ensure minimal disruption to oncoming vehicles. Therefore, an algorithm to generate efficient, smooth, and risk-aware deviation paths with respect to a fixed reference path to handle such situations is desired. The algorithm for local path planning may be implemented as a computer-implemented method 100 for local path planning and may simultaneously address path smoothness (e.g., resulting kinematic/dynamic feasibility) and computational efficiency as a practical benefit.

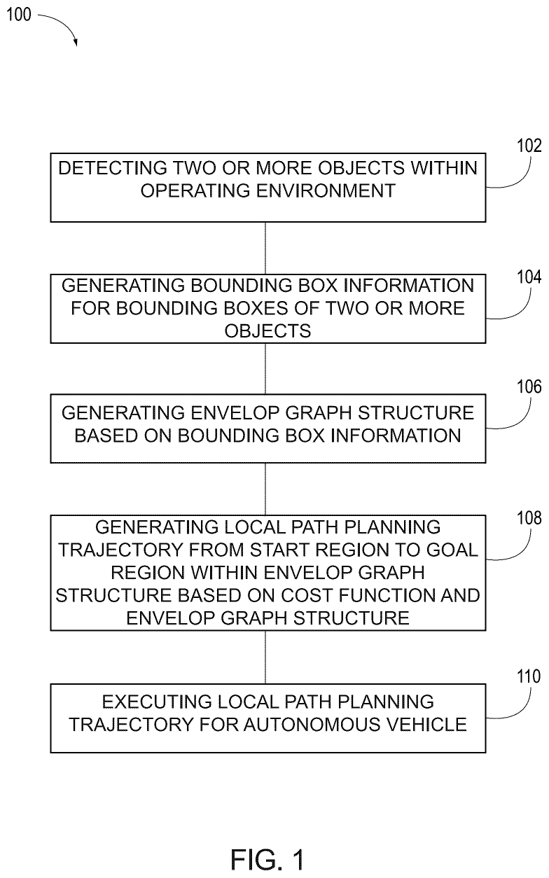

FIG. 1 is an exemplary flow diagram of a computer-implemented method 100 for local path planning, according to one aspect. The computer-implemented method 100 for local path planning may include detecting 102 two or more objects within an operating environment, generating 104 bounding box information for bounding boxes of the two or more objects, generating 106 an envelop graph structure based on the bounding box information, generating 108 a local path planning trajectory from a start region to a goal region within the envelop graph structure based on a cost function and the envelop graph structure, and executing 110 the local path planning trajectory for the autonomous vehicle.

Generally, a system 200 for local path planning may generate a smooth path around objects by combining cubic splines while retaining high efficiency. Leveraging a sparse graph structure facilitated by admissible heuristics described in greater detail herein, the system 200 for local path planning may dynamically identify object-specific nodes in a continuous Frenet space (e.g., Frenet-Serret) while accounting for perception noise. The edges between nodes, given by cubic splines, may be assigned costs including metrics embodying path smoothness and risk associated with other road users. A final path for a local path planning trajectory may be evaluated as a minimum cost path connecting the start and goal nodes or regions.

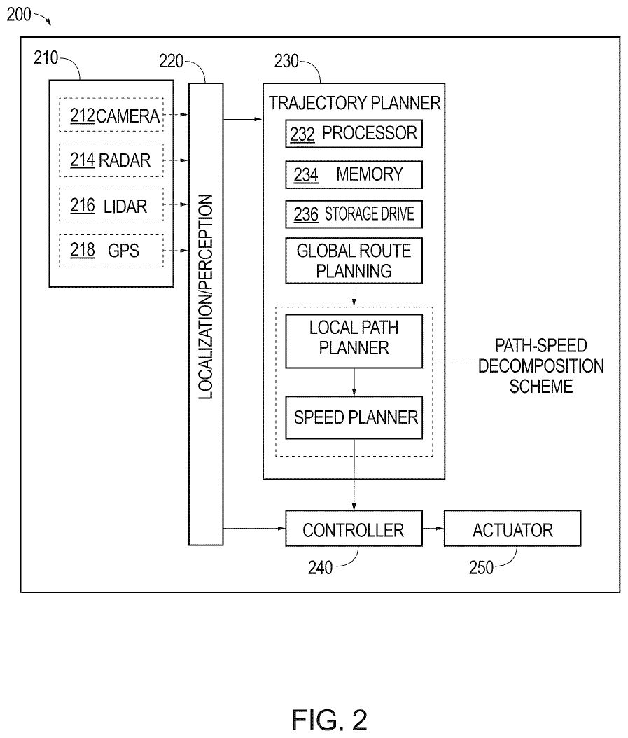

FIG. 2 is an exemplary component diagram of a system for local path planning, according to one aspect. The system for local path planning may include one or more sensors 210, such as a camera 212, radar 214, lidar 216, a global positioning system (GPS) 218, etc. The system for local path planning may include a perception localizer and a trajectory planner 230. The trajectory planner 230 may be implemented via a processor 232, a memory 234, and a storage drive 236 to perform global route planning, local path planning, speed planning, etc. to generate a local path planning trajectory based on a path-speed decomposition scheme. Additionally, the system for local path planning may include a controller 240 and an actuator 250.

The perception localizer 220 and/or the trajectory planner 230 may be implemented via the processor 232, the memory 234, and the storage drive 236 to perform local path planning. The memory 234 may store one or more instructions. The storage drive may store the generated envelop graph. The processor 232 may execute one or more of the instructions stored on the memory 234 to perform one or more acts, actions, and/or steps described herein.

It may be seen from FIG. 2 that the system for local path planning implements a modular architecture that decomposes the trajectory planning problem into two sub-problems (e.g., path planner and speed planner). This decoupled scheme facilitates the decomposition of the overall problem complexity, leading to the advantage of a computationally efficient trajectory local path planning algorithm. The first sub-problem includes devising a local path planning strategy that takes a predefined global path from the global route planner and dynamically adjusts it to accommodate real-time static objects. The global route planner may generate a global path for the ego-vehicle to reach its desired destination. For example, the global route planner may generate a reference path or global path from a start region to a goal region. This global path may be dynamically updated by the local path planner to cater to the environmental entities observed in real-time.

The second subproblem focuses on generating a speed profile along this locally modified path to cater to the dynamic objects. In this way, the system for local path planning primarily addresses the first sub-problem, overview of the speed planning aspect for completeness. According to one aspect, a Multi-Profile Quadratic Programming (MPQP) approach may be implemented, leveraging a high level of mathematical rigor and optimality guarantees. The MPQP method includes projecting the objects onto a space-time graph, relative to the path generated by the local path planner and utilizing a breadth-first search to explore various timing possibilities, such as passing behind or ahead of an on-road agent. These options establish lower and upper bounds in space-time, which may then be enforced as constraints in a quadratic program. Notably, this approach maintains optimality without resorting to any additive approximations, thus yielding an optimal speed profile. However, any speed planner may be utilized.

### Local Path Planning

Given the global path (herein “reference path”), the processor 232 may generate a local path adaptive to one or more objects present along the reference path. In this way, the local planning framework may have the processor 232 perform the following: (i) generating bounding boxes in the Frenet-Serret frame for the currently visible objects; (ii) generating an “envelop graph” where the corner points of relevant bounding boxes may be the nodes and the intersection-free splines between them may be the edges; and, (iii) finding the minimum cost path between the start and goal nodes of the envelop graph.

To bound the maximum deviation from the reference path, the processor 232 may utilize the Frenet-Serret frame relative to the reference path. In this frame, the longitudinal s-axis may be aligned with the reference path, while the lateral d-axis may indicate an orthogonal deviation from the reference path.

The sensors 210 may detect two or more objects (e.g., obstacles, pedestrians, other vehicles, cyclists, motorcyclists, static objects, etc.) within an operating environment.

### Bounding Box Generation

The processor 232 (e.g., perception localizer 220) may generate bounding box information for two or more bounding boxes corresponding to the two or more objects. The bounding box information may include a position, a size, and an orientation for a corresponding bounding box. Considering any noise in the data gathered from the perception localizer 220, consistent or updated measurements of objects' positions, orientations, and sizes may be useful for effective local path planning.

Two primary methodologies may be employed to address the perception noise in robust and probabilistic bounding box estimation. Both the robust and probabilistic bounding box generation strategies amidst noisy perception data. The robust approach includes creating a rectangle that encloses all perceived positions of the object, yielding robust guarantees. However, the conservative nature of the robust approach may lead to a “freezing robot problem”, potentially stranding the ego-vehicle unnecessarily. Alternatively, the probabilistic approach may include generating rectangles based on the real-time evaluation of noise distribution. In this regard, the probabilistic approach for bounding boxes may be implemented due to the simplicity and the balance between risk and consistency.

Let [symbol] denote a set of observable objects at a current time instant and let B denote the set of bounding boxes for all o∈ [symbol] . It may be assumed that the underlying distributions governing each bounding box's position, orientation, and size are independent Gaussians with known variances. Under this assumption, the processor 232 may obtain mean estimates of position, orientation, and size using the unbiased Maximum Likelihood Estimator, which corresponds to a sample means. Formally, this may be represented as

$${\hat{k}}_{i} = \frac{1}{N} {\sum }_{n = 1}^{N} {\tilde{k}}_{i}^{n}$$

where N corresponds to the number of observed samples, \hat{k}ᵢ is a generic variable used to represent the estimated position, length, width, or orientation of a given bounding box, while \tilde{k}ᵢⁿ represents the observed value of the variable under consideration. The size estimates may be further augmented by an additive margin to incorporate an extra buffer.

The estimated positions of pedestrians in the environment may be clustered using a density-based clustering algorithm. Then, for each individual cluster, vertices of a convex hull enclosing its respective constituents may be identified. Therefore, a bounding box with respect to these vertices, augmented by an additive margin, may be generated, and added to the set B. In any event, the bounding box information may be passed on to the trajectory planner 230, which may perform global route planning, local path planning, and speed planning.

The processor 232 may generate an envelop graph structure based on the bounding box information. The envelop graph structure envelops or fully encloses all of the bounding boxes associated with the objects and is thus referred to as the “envelop graph” structure.

### Dynamic Obstacles

To handle dynamic obstacles, the processor may utilize a decision-making module to determine when a dynamic obstacle is to be circumvented or not. For example, a slow-moving vehicle looking for a parking spot on the roadside may be maneuvered around, but a vehicle approaching an intersection cautiously may be followed at a threshold following distance. In this regard, the processor may utilize a decision making-module to generate a path to circumvent a dynamic obstacle identified by such a decision-making module. To do that, the position of the dynamic obstacle may be determined based on the predictions of a trajectory module, and the non-contiguous bounding boxes along the trajectory may be considered independently for deviation by adding them to [symbol] .

### Envelop Graph Generation

Once each bounding box's position, size, and orientation have been determined, the processor 232 may generate the envelop graph. Bounding boxes i∈B that lie on the reference path may be identified and provided to the processor 232 as input. These bounding boxes may be represented by Bᵣ. Thereafter, processor may perform the graph generation by the following: (i) for each i∈Bᵣ, add the opposing corners of the bounding box with the maximum

$$( {d}_{max}^{i} )$$

and minimum

$$( {d}_{min}^{i} )$$

lateral displacements relative to the reference path to the node set [symbol] ; and (ii) generate cubic splines between the identified nodes and add the intersection-free splines to the edge set [symbol] .

### Node Set Determination

The envelop graph structure may include a plurality of nodes defined by the position of corresponding bounding boxes. To be able to circumvent an object on either of an ego-vehicle's sides, the bounding box corners corresponding to

$${d}_{max}^{i}$$

and

$${d}_{min}^{i} ,$$

lying within a drivable region, are stored in the node set [symbol] . The processor 232 may connect nodes corresponding to different objects with cubic splines to allow for the generation of path candidates that traverse the entire object set [symbol] smoothly without unnecessarily wiggling into spaces between different objects. To further enhance this smooth traversal, the processor 232 may add all four corners of a bounding box if the bounding box is oriented in the direction of the reference path or perpendicular to the reference path. For example, the reference path aligned edges of the bounding box may be stored directly as edges in the edge set [symbol] .

The start nodes and goal nodes (e.g., corresponding to the start and goal regions, respectively), corresponding to the points on the reference path to start deviating from or merging back to the reference path, may be defined such that their lateral displacements may be 0, while their longitudinal displacements may be restricted to regions defined by S and [symbol] . These regions may be determined dynamically as functions of the ego-vehicle's current speed, allowing for a greater headway when the ego-vehicle approaches at higher speeds, facilitating smoother circumvention of objects. Moreover, defining the start nodes and the goal nodes within these regions offers the flexibility to choose different points as nodes, allowing the processor 232 to maximize path smoothness during the edge generation process. Formally, the distances dₛ and d_{g} of the regions S and [symbol] from a first and a last object, respectively, may be given as follows:

$${d}_{i} = max ( min ( {k}_{i} \cdot {v}_{ego} \cdot {t}_{lc} , {d}_{max}^{lc} ) , {d}_{min}^{lc} ) , i ∈ \{ s , g \} \qquad ( 1 )$$

where v_{ego} corresponds to ego-vehicle's velocity, t_{lc} represents the time required to change lanes at a unit speed, kᵢ may be a proportionality constant, and

$${d}_{min}^{l c} and {d}_{max}^{l c}$$

denote the minimum and maximum bounds for lane deviation distances.

### Edge Set Generation

For the nodes corresponding to different objects in Bᵣ, the set of all edges S between the respective nodes may be given by cubic splines. It may be shown based on the differential flatness theory that the nonlinear kinematic bicycle model may be automatically satisfied by a bounded curvature cubic spline path representation, ensuring the dynamic feasibility of edges in S. These edges may be then evaluated for intersections with bounding boxes in B, and the intersection-free edges may be stored in the edge set [symbol] .

A cubic spline, or a third-order polynomial curve, may be governed by four independent parameters. The processor may treat the variations in the longitudinal and lateral components independently with respect to the independent arc length parameter s, which provides more freedom over the shape of the resulting curve. The longitudinal x(s) and lateral y(s) curves may be parameterized as:

$$x ( s ) = {p}_{0}^{x} + {p}_{1}^{x} s + {p}_{2}^{x} {s}^{2} + {p}_{3}^{x} {s}^{3} \qquad ( 2 )$$

$$y ( s ) = {p}_{0}^{y} + {p}_{1}^{y} s + {p}_{2}^{y} {s}^{2} + {p}_{3}^{y} {S}^{3}$$

where

$$\{ {p}_{0}^{x} , … , {p}_{3}^{x} , {p}_{0}^{y} , … , {p}_{3}^{y} \}$$

set of parameters to be estimated or evaluated. To obtain the eight independent equations to solve for the eight unknown parameters, function evaluations and their derivatives at the known start (x₀, y₀, θ₀, v₀) and end points (x₁, y₁, θ₁, v₁) of the curve. The eight equations may be then formulated in a matrix form as:

$${\underbrace{[ \begin{matrix}1 & {s}_{0} & {s}_{0}^{2} & {s}_{0}^{3} \\ 0 & 1 & 2 {s}_{0} & 3 {s}_{0}^{2} \\ 1 & {s}_{1} & {s}_{1}^{2} & {s}_{1}^{3} \\ 0 & 1 & 2 {s}_{1} & 3 {s}_{1}^{2}\end{matrix} ]}}_{A} {\underbrace{[ \begin{matrix}{p}_{0}^{x} \\ {p}_{1}^{x} \\ {p}_{2}^{x} \\ {p}_{3}^{x}\end{matrix} ]}}_{{p}^{x}} = {\underbrace{[ \begin{matrix}{x}_{0} \\ {v}_{0} cos ( {θ}_{0} ) \\ {x}_{1} \\ {v}_{1} cos ( {θ}_{1} )\end{matrix} ]}}_{{b}^{x}} \qquad ( 3 )$$

$${\underbrace{[ \begin{matrix}1 & {s}_{0} & {s}_{0}^{2} & {s}_{0}^{3} \\ 0 & 1 & 2 {s}_{0} & 3 {s}_{0}^{2} \\ 1 & {s}_{1} & {s}_{1}^{2} & {s}_{1}^{3} \\ 0 & 1 & 2 {s}_{1} & 3 {s}_{1}^{2}\end{matrix} ]}}_{A} {\underbrace{[ \begin{matrix}{p}_{0}^{y} \\ {p}_{1}^{y} \\ {p}_{2}^{y} \\ {p}_{3}^{y}\end{matrix} ]}}_{{p}^{y}} = {\underbrace{[ \begin{matrix}{y}_{0} \\ {v}_{0} cos ( {θ}_{0} ) \\ {y}_{1} \\ {v}_{1} cos ( {θ}_{1} )\end{matrix} ]}}_{{b}^{y}} \qquad ( 4 )$$

where, s₀=0 while s₁=α·∥[x₀ x₁]^{T}−[y₀ y₁]^{T}∥ and α>1 is a hyperparameter that governs the total length of the resulting curve. The unknown parameter vectors pₓ and p_{y} may be obtained analytically by solving these systems of equations to yield a constant computational complexity of [symbol] (1).

To choose specific points (s and g) within the start and goal regions (S and [symbol] ) for spline generation corresponding to each node n∈ [symbol] , a heuristic based on the lateral distance may be introduced. Specifically, the start and goal nodes on the reference path may be chosen such that the longitudinal distances of the points from the object set Bᵣ may be proportional to the lateral distance of the node under consideration. This ensures that if the ego-vehicle has to travel a greater lateral distance to or from the node, it will start or end its maneuver at a greater longitudinal distance within the predefined region bounds (S, [symbol] ) to preserve path smoothness. This approach mitigates the smoothness limitation of cubic splines (e.g., compared to quintic splines) by generating paths with respect to objects as opposed to the ego-vehicle's position. In this way, the envelop graph structure may include a cubic spline path representation including nodes having a maximum lateral displacement from the reference path from the start region to the goal region.

### Cost Function

The edges in edge set [symbol] may be assigned costs determined by a linear combination of penalty or cost functions including: (i) average divergence; (ii) path smoothness; (iii) average minimum distance to objects; and, (iv) risk to surrounding agents (e.g., other road users) that may be not on the reference path. Each of these penalty functions may be elaborated upon in the following sections. The final path connecting the start (s) and goal (g) nodes on envelop graph may be the minimum cost path, found by Dijkstra's algorithm, for example.

According to one aspect, the cost function may be based on an average divergence from a reference path from the start region to the goal region, smoothness of the local path planning trajectory, an average minimum distance to the two or more objects, and a type of object. The type of object may include a vehicle, a pedestrian, a motorcycle, a number of axles associated with the vehicle, etc.

### Average Divergence

For an edge E∈ [symbol] , the average divergence penalty may correspond to a mean lateral deviation of E from the reference path. This penalty encourages the cost function to pick edges with less overall deviation from the reference path. Formally, this penalty function may be represented as:

$${g}_{div}^{E} = {μ}_{e ∈ E} ( \begin{matrix}min \\ r ∈ ref\end{matrix} ( ‖ e - r ‖ ) ) \qquad ( 5 )$$

where e corresponds to the coordinates of edge E and r to the coordinates of the reference path, while μ_{e∈E} corresponds to the sample mean over E.

### Path Smoothness

For an edge E∈ [symbol] , path smoothness may be defined as the average change in divergence, or lateral deviation, between the consecutive waypoints of E. This penalty may indicate a preference for paths with less abrupt lateral changes to enhance passenger comfort. Formally, it may be defined in the Frenet frame as:

$${g}_{smooth}^{E} = {μ}_{e ∈ {E}^{*}} ( {d}_{{e}^{*}} - {d}_{e} ) \qquad ( 6 )$$

where E* corresponds to the subset of E with the last waypoint removed, dₑ corresponds to the lateral coordinate of e and d_{e*} corresponds to the lateral coordinate of the successive waypoint of e, and μ_{e∈E*} corresponds to the sample mean over E*.

### Average Minimum Distance to Objects

For an edge E∈ [symbol] , the mean minimum distance penalty may be formulated as the reciprocal of the mean minimum distance to the objects. This penalty encourages the cost function to pick a path with a larger gap to all the objects. Formally, it may be defined as:

$${g}_{dist}^{E} = \frac{1}{{μ}_{o ∈ 𝒪} ( {min}_{e ∈ E} ( ‖ q ( o ) - e ‖ ) )} \qquad ( 7 )$$

### Risk to Surrounding Agents

This penalty may be associated with the risk pertaining to surrounding agents, especially other road users (e.g., pedestrians, cyclists), that may not be accounted for explicitly in the edge generation process. Specifically, since the node set [symbol] accounts only for the bounding boxes in Bᵣ as they may be the ones relevant to the local path planning scheme, the objects in [symbol] corresponding to B\Bᵣ may be implicitly accounted for in the edge selection process. This ensures that once collision avoidance is established, the path that poses the minimum risk to the neighboring agents may be selected by the processor 232.

The modularity of the approach allows for a choice of a wide variety of risk metrics encompassing coherent risk metrics, entropy-based measures, and distribution-based measures. For the purpose of local path planning, a proximity-based measure suffices, such that the path that maintains the greater distance to the nearest agent may be preferred. This may be formulated as:

$${g}_{risk}^{E} = \frac{1}{{min}_{b ∈ B ∖ {B}_{r}} ( {min}_{e ∈ E} ( ‖ q ( b ) - e ‖ ) )} \qquad ( 8 )$$

where q:B→ [symbol] ² may be a function that extracts the position of bounding box b.

### Total Cost

The total cost J^{E} of an edge E∈ [symbol] may be given by the linear combination of the previously defined costs as follows:

$${J}^{E} = {w}_{div} {g}_{div}^{E} + {w}_{smooth} {g}_{smooth}^{E} + {w}_{dist} {g}_{dist}^{E} + {w}_{risk} {g}_{risk}^{E} \qquad ( 9 )$$

where w{⋅} may be an associated weight responsible for normalizing and weighting each penalty function. According to one aspect, the processor 232 may favor smoother paths with minimal divergences, and may prioritize maintaining greater distance from pedestrians, motorcyclists, or non-vehicle road users, etc. In this way, the cost function allows for different penalty function choices, enabling design modularity.

### Computational Complexity Reduction

The computational bottleneck in the processor 232 may be the edge generation phase that includes spline generation and intersection evaluations. The processor 232 relies on the envelop graph, a sparse graph structure, to ensure that the algorithm's computational complexity remains low. To maintain graph sparsity, admissible heuristics may be implemented to ensure minimal redundant edges may be generated, minimizing intersection evaluations while ensuring not to sacrifice performance.

Firstly, only generate splines between a node and the nodes following it longitudinally to avoid redundancies since the spline generation process may be direction-agnostic. Moreover, prevent further redundant spline generation by noting that an intersection-free spline may only be generated between two nodes if no intermediary bounding box laterally protrudes beyond the limits set by the minimum and maximum lateral displacements of the two nodes since a cubic spline only allows for one “kink” in the curve. Finally, add edges between two nodes only if the ratio of the lateral and longitudinal distances between them may be within a pre-defined threshold in order to keep the maximum path curvature bounded; this ensures the dynamic feasibility of the path. These heuristics ensure that no optimal feasible path will be discarded, making them admissible heuristics.

In this way, an edge of the envelop graph structure may be generated between a first node and a second node only if the second node follows the first node longitudinally. An edge of the envelop graph structure may be generated between a first node and a second node only if the edge does not intersect any bounding box. An edge of the envelop graph structure may be generated between a first node and a second node only if the edge satisfies a predetermined lateral distance to longitudinal distance ratio.

These heuristics yield a worst-case computational complexity of [symbol] (|Bᵣ|²), where |Bᵣ| corresponds to the number of bounding boxes in Bᵣ. This may be significantly lower than the complexity of a naive approach. For context, a naive approach may be one that generates a fixed number of candidates per object and sums up all the combinations of candidates to generate candidate paths, which may be then checked for intersection with bounding boxes. The worst-case complexity for the naive algorithm may be

$$𝒪 ( {N}_{c a n d}^{2 \vert {B}_{r} \vert} )$$

combinatorial with respect to the number of candidates (N_{cand}) and exponential with respect to |Bᵣ|. To contextualize, in the case of 4 objects (e.g., |Bᵣ|=4) and 4 spline candidates per object (e.g., N_{cand}=4), the number of candidate paths generated by the processor 232 may be up to 32 as opposed to 65536 generated by the naive approach.

The processor 232 may generate a local path planning trajectory from the start region to the goal region within the envelop graph structure based on a cost function and the envelop graph structure. Additionally, the speed planner may generate a speed profile on top of this local path.

The combined path and speed profiles, collectively referred to as a local path planning trajectory, may be then passed to the downstream controller. The controller 240 may utilize a decoupled control scheme where a longitudinal control may be governed by a proportional integral derivative (PID) controller, while a lateral control may be performed by a model predictive controller (MPC). In this way, the controller 240 may include the PID controller and the MPC controller. The PID controller may be tuned with a simulator, and the MPC controller may be designed with a one-time-step planning horizon based on a vehicle rotation model. In this way, the controller 240 may control the actuator 250 to execute the local path planning trajectory for the autonomous vehicle.

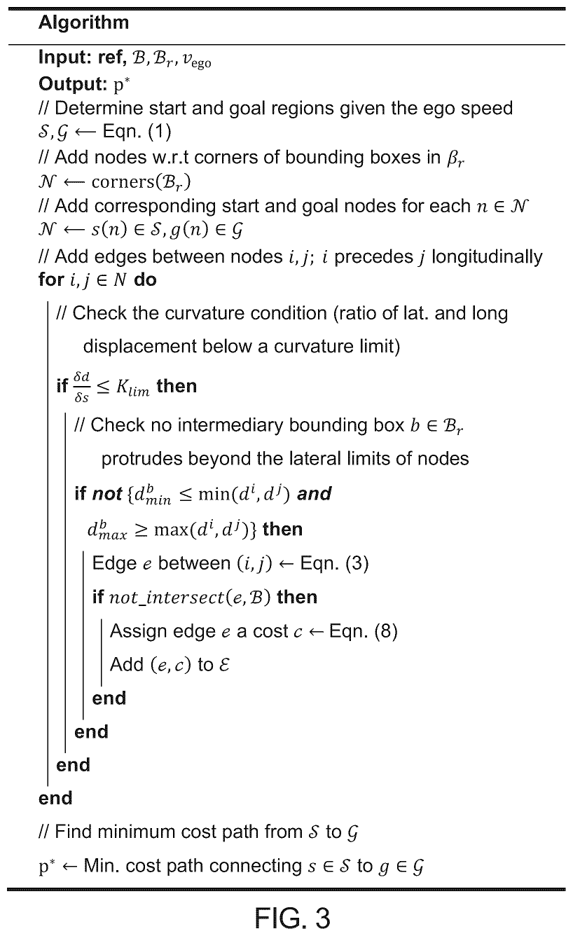

FIG. 3 is an exemplary algorithm in association with the computer-implemented method for local path planning of FIG. 1 and the system for local path planning of FIG. 2, according to one aspect. The algorithm may be executed by the processor 232 to perform a computer-implemented method for local path planning. For example, the processor 232 may determine start and goal regions based on a velocity of the ego-vehicle, generate nodes for corners of bounding boxes associated with objects in the operating environment, add edges between nodes that follow another node longitudinally, add edges between nodes based on a curvature ratio, add edges between nodes based on no bounding box intersecting the edge, and determine a minimum cost path based on a cost function.

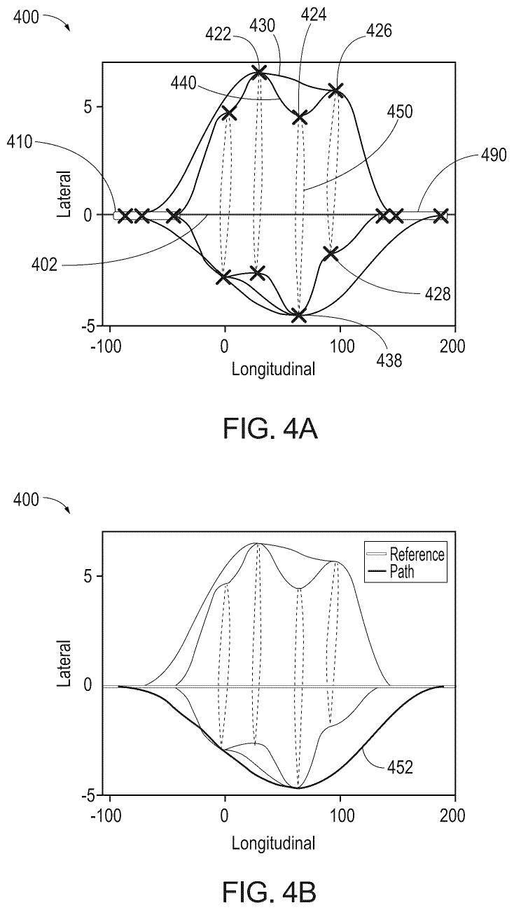

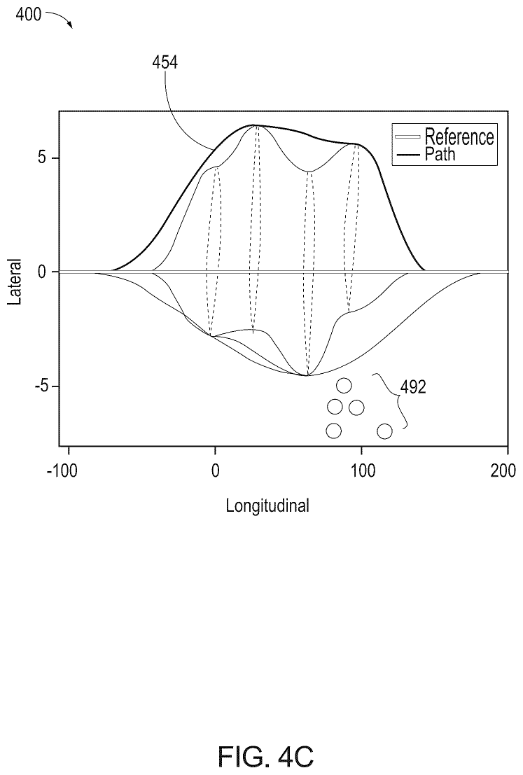

With reference to FIG. 4A and the computational complexity reduction, for example, it may be seen that there is a reference path 402 from a starting region 410 to a goal region 490, a first node 422, a second node 424, a third node 426, and a fourth node 428. According to one aspect, the processor 232 may generate splines (e.g., edges) 430 and 440 because node 424 follows node 422 and node 426 follows node 422 longitudinally. According to one aspect, node 422 cannot form an edge with node 428 due to a potential intersection with bounding box 450. According to one aspect, node 422 cannot form an edge with node 438 due to exceeding a predetermined lateral distance to longitudinal distance ratio, for example.

FIGS. 4A-4C are exemplary graphs in association with local path planning, according to one aspect. In the graph 400 of FIG. 4A, the lateral axes may be scaled to distinguish the candidate paths. During envelop graph generation, the reference path may be represented by the horizontal line, while the start (S) and goal ( [symbol] ) regions on the reference path may be represented by blocks. The nodes in [symbol] may be represented by the crosses, while the edges in E may be represented by the various splines. In FIG. 4B, optimal path choice without pedestrians is illustrated. According to one aspect, the local path planning trajectory obtained via the processor 232 is path 452. In FIG. 4C, optimal path selection occurs with pedestrians 492 present. The path generated via the processor 232 with pedestrians (e.g., dots) present is indicated by the path 454.

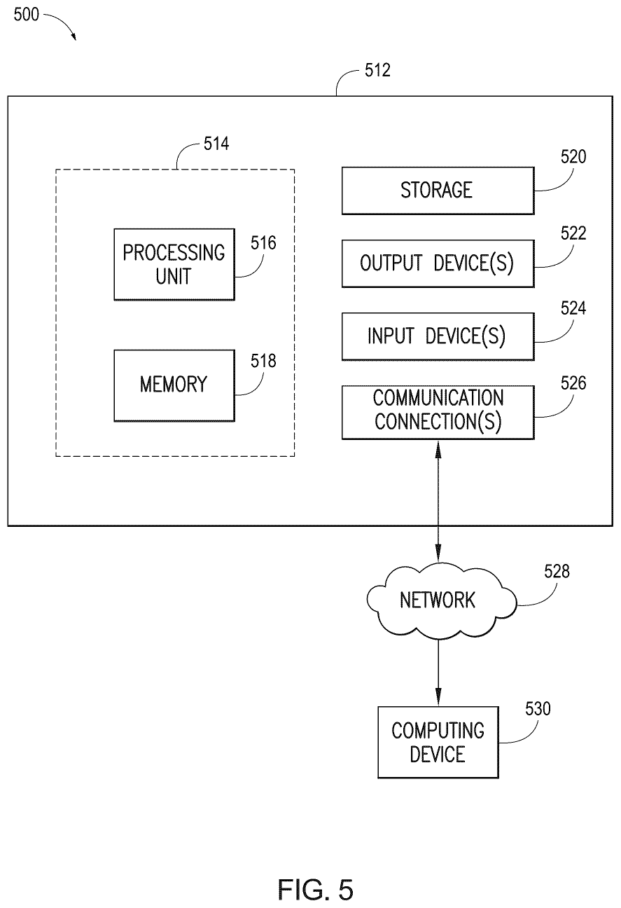

FIG. 5 and the following discussion provide a description of a suitable computing environment to implement aspects of one or more of the provisions set forth herein. The operating environment of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, which perform one or more tasks or implement one or more abstract data types. Typically, the functionality of the computer readable instructions are combined or distributed as desired in various environments.

FIG. 5 illustrates a system 500 including a computing device 512 configured to implement one aspect provided herein. In one configuration, the computing device 512 includes at least one processing unit 516 and memory 518. Depending on the exact configuration and type of computing device, memory 518 may be volatile, such as RAM, non-volatile, such as ROM, flash memory, etc., or a combination of the two. This configuration is illustrated in FIG. 5 by dashed line 514.

In other aspects, the computing device 512 includes additional features or functionality. For example, the computing device 512 may include additional storage such as removable storage or non-removable storage, including, but not limited to, magnetic storage, optical storage, etc. Such additional storage is illustrated in FIG. 5 by storage 520. In one aspect, computer readable instructions to implement one aspect provided herein are in storage 520. Storage 520 may store other computer readable instructions to implement an operating system, an application program, etc. Computer readable instructions may be loaded in memory 518 for execution by the at least one processing unit 516, for example.

The term “computer readable media” as used herein includes computer storage media. Computer storage media includes volatile and nonvolatile, removable, and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 512. Any such computer storage media is part of the computing device 512.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 512 includes input device(s) 524 such as keyboard, mouse, pen, voice input device, touch input device, infrared cameras, video input devices, or any other input device. Output device(s) 522 such as one or more displays, speakers, printers, or any other output device may be included with the computing device 512. Input device(s) 524 and output device(s) 522 may be connected to the computing device 512 via a wired connection, wireless connection, or any combination thereof. In one aspect, an input device or an output device from another computing device may be used as input device(s) 524 or output device(s) 522 for the computing device 512. The computing device 512 may include communication connection(s) 526 to facilitate communications with one or more other devices 530, such as through network 528, for example.

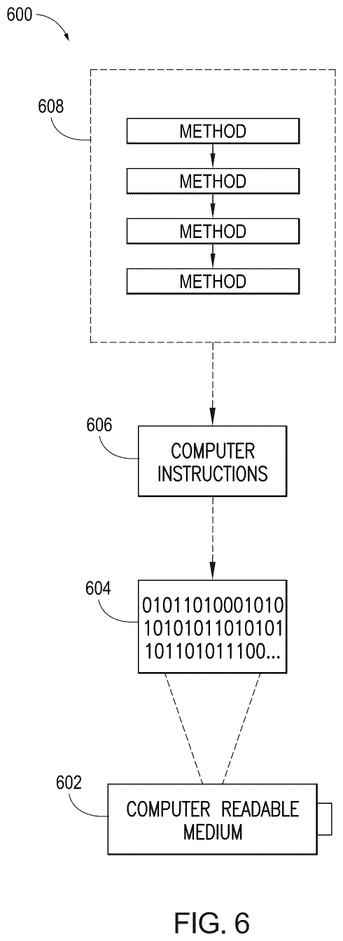

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 602, such as a CD-R, DVD-R, flash drive, a platter of a hard disk drive, etc., on which is encoded computer-readable data 604. This encoded computer-readable data 604, such as binary data including a plurality of zero's and one's as shown in 604, in turn includes a set of processor-executable computer instructions 606 configured to operate according to one or more of the principles set forth herein. In this implementation 600, the processor-executable computer instructions 606 may be configured to perform a method 608, such as the computer-implemented method 100 for local path planning of FIG. 1. In another aspect, the processor-executable computer instructions 606 may be configured to implement a system, such as the system 200 for local path planning of FIG. 2. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for local path planning, comprising:
a memory storing one or more instructions; and
a processor executing one or more of the instructions stored on the memory to perform:
generating an envelop graph structure based on bounding box information for bounding boxes of two or more objects within an operating environment; and
generating a local path planning trajectory from a start region to a goal region within the envelop graph structure based on a cost function and the envelop graph structure.

2. The system for local path planning of claim 1, wherein the bounding box information includes a position, a size, and an orientation for a corresponding bounding box.

3. The system for local path planning of claim 2, wherein the envelop graph structure includes a plurality of nodes defined by the position of corresponding bounding boxes.

4. The system for local path planning of claim 1, wherein the envelop graph structure includes a cubic spline path representation including nodes having a maximum lateral displacement from a reference path from the start region to the goal region.

5. The system for local path planning of claim 1, wherein an edge of the envelop graph structure is generated between a first node and a second node only if the second node follows the first node longitudinally.

6. The system for local path planning of claim 1, wherein an edge of the envelop graph structure is generated between a first node and a second node only if the edge does not intersect any bounding box.

7. The system for local path planning of claim 1, wherein an edge of the envelop graph structure is generated between a first node and a second node only if the edge satisfies a predetermined lateral distance to longitudinal distance ratio.

8. The system for local path planning of claim 1, wherein the cost function is based on an average divergence from a reference path from the start region to the goal region, smoothness of the local path planning trajectory, an average minimum distance to the two or more objects, and a type of object.

9. The system for local path planning of claim 8, wherein the type of object includes a vehicle, a pedestrian, or a motorcycle.

10. The system for local path planning of claim 1, comprising a controller controlling an actuator to execute the local path planning trajectory for an autonomous vehicle.

11. A computer-implemented method for local path planning, comprising:
generating an envelop graph structure based on bounding box information for bounding boxes of two or more objects within an operating environment; and
generating a local path planning trajectory from a start region to a goal region within the envelop graph structure based on a cost function and the envelop graph structure.

12. The computer-implemented method for local path planning of claim 11, wherein the envelop graph structure includes a cubic spline path representation including nodes having a maximum lateral displacement from a reference path from the start region to the goal region.

13. The computer-implemented method for local path planning of claim 11, wherein an edge of the envelop graph structure is generated between a first node and a second node only if the second node follows the first node longitudinally.

14. The computer-implemented method for local path planning of claim 11, wherein an edge of the envelop graph structure is generated between a first node and a second node only if the edge does not intersect any bounding box.

15. The computer-implemented method for local path planning of claim 11, wherein an edge of the envelop graph structure is generated between a first node and a second node only if the edge satisfies a predetermined lateral distance to longitudinal distance ratio.

16. An autonomous vehicle with local path planning, comprising:
a sensor detecting two or more objects within an operating environment;
a memory storing one or more instructions;
a processor executing one or more of the instructions stored on the memory to perform:
generating bounding box information for bounding boxes of the two or more objects;
generating an envelop graph structure based on the bounding box information; and
generating a local path planning trajectory from a start region to a goal region within the envelop graph structure based on a cost function and the envelop graph structure; and
a controller controlling an actuator to execute the local path planning trajectory for the autonomous vehicle.

17. The autonomous vehicle with local path planning of claim 16, wherein the envelop graph structure includes a cubic spline path representation including nodes having a maximum lateral displacement from a reference path from the start region to the goal region.

18. The autonomous vehicle with local path planning of claim 16, wherein an edge of the envelop graph structure is generated between a first node and a second node only if the second node follows the first node longitudinally.

19. The autonomous vehicle with local path planning of claim 16, wherein an edge of the envelop graph structure is generated between a first node and a second node only if the edge does not intersect any bounding box.

20. The autonomous vehicle with local path planning of claim 16, wherein an edge of the envelop graph structure is generated between a first node and a second node only if the edge satisfies a predetermined lateral distance to longitudinal distance ratio.
